(19) United States
(12) Patent Application Publication
(10) Pub. No.: US 2025/0319514 A1
(43) Pub. Date: Oct. 16, 2025

(54) METHOD FOR PRODUCING A THREE-DIMENSIONAL METAL MOLDING BODY HAVING AN OPEN-CELL METAL SPONGE STRUCTURE

(71) Applicant: Grillo-Werke AG, Duisburg (DE)

(72) Inventors: Kathrin HESNAOUI, Duisburg (DE); Jürgen WISNIEWSKI, Duisburg (DE); Petra GEHRKE, Duisburg (DE); Armin MELZER, Duisburg (DE); Frank PRENGER, Duisburg (DE); Silke Müller, Duisburg (DE)

(21) Appl. No.: 18/709,557

(22) PCT Filed: Nov. 11, 2022
(86) PCT No.: PCT/EP2022/081588

§ 371 Date: Oct. 8, 2024

(30) Foreign Application Priority Data
Nov. 16, 2021 (EP) 21208534.4

(51) Int. Cl. B22D 18/06; B22D 21/02; B22D 25/06; H01M 4/02; H01M 4/04; H01M 4/42; H01M 4/80

(52) U.S. Cl. CPC B22D 18/06; B22D 21/027; B22D 25/06; H01M 4/0433; H01M 4/42; H01M 4/808; H01M 2004/021; H01M 2004/027

(57) ABSTRACT

The present invention relates to a method for producing an open-cell metal molding body from zinc, tin, lead, indium, aluminum, magnesium or bismuth, or from alloys of such metals, and to the use of the obtained metal molding body as an anode.

### TECHNICAL FIELD

The present invention relates to a process for preparing metallic molded parts having an open-cell structure made of zinc, tin, lead, indium, aluminum, magnesium, bismuth, or suitable alloys of such metals, the metallic molded parts thus obtained, and the use thereof, in particular, as an anode in batteries, rechargeable batteries, and all-solid-state batteries.

### INTRODUCTION

Batteries and, in particular, rechargeable batteries play a critical role in the so-called energy revolution. The application thereof is planned for both stationary cases and network-stabilizing storage (energy-storage) systems. Energy-storage systems are also employed in the household field, especially for storing solar energy. However, they are also increasingly employed in vehicles or in the consumer field.

Rechargeable batteries based on porous metallic molded parts have a great potential as an alternative for nickel-metal hydride, lead-acid, and even lithium-ion rechargeable batteries. Most widespread and most generally known are lithium-ion rechargeable batteries from the consumer field, and lead rechargeable batteries from vehicles.

However, especially lithium-containing rechargeable (or secondary) batteries are increasingly subject to criticism, since the mining of lithium is often associated with a high level of environmental pollution. In addition, the resources are limited. In nickel-metal hydride rechargeable batteries, rare earth elements, such as cerium and lanthanum, are employed.

Recently, zinc has gained importance as an alternative material for primary and secondary batteries. For example, zinc-based sponge anodes have a considerable advantage over lead anodes in terms of density. When zinc is employed as a battery material, shortage of the raw material is not to be expected even in a mass production. In addition, rare metals or rare earths are not used, and recyclability makes the use thereof additionally sustainable. In addition, zinc electrodes offer a high potential, which is why they can be employed in the field of primary batteries.

Concerns that exist, for example, in terms of safety (risk from inflammable components) in lithium ion rechargeable batteries do not exist in Zn batteries. Zinc batteries most commonly contain water-based electrolytes, which are thus non-flammable.

Zinc electrodes are normally prepared for for batteries (such as Ni/Zn; Zn/air; Zn/Ag; Zn/Mn; or Zn/bromine batteries) made of powders (Trueb & Rüetschi, 1998, Batterien und Akkumulatoren. Springer publishers). Thus, the zinc powder is pressed, or admixed with additives and pressed, e.g., in a calander method (Birke & Schiemann, 2013, Akkumulatore Vergangenheit, Gegenwart und Zukunft Energiespeicher. Munich: Herbert Utz Verlag GmbH). Another possibility is sintering (U.S. Pat. No. 3,663,297A).

One fundamental precondition of the technical feasibility of a zinc rechargeable battery, i.e., a rechargeable battery with an electrode, especially anode, made of zinc, is the cycle stability for a high power of the cell. In the past, the problems with zinc electrodes were due to structural changes that occurred during the charging/discharging processes.

Known causes thereof include dendrite growth and the so-called “shape change” effect. “Dendrite growth” means the growing of lengthy crystal structures on the zinc electrode during the charging process, which may lead to internal short circuits and thus to failure of the cell. The “shape change effect” means a local zinc precipitation in the lower electrode region caused by inhomogeneous current distribution and gravitational effects. This geometry change of the electrode may ultimately also lead to a short circuit and thus to failure of the cell.

Electrode structuring is an approach already known from the literature to avoid failure of the cell (Trueb & Rüetschi, 1998, Batterien und Akkumulatoren. Springer publishers, p. 111). Three-dimensional anode structures show a great advantage in terms of rechargeability by avoiding structural deficiencies. The approaches of preparing three-dimensional electrode structures are based on the use of battery powder. The porous zinc structures are prepared by wet chemistry (Joseph F. Parker, C. N. (Apr. 28, 2017). Rechargeable nickel-3D zinc batteries: An energy-dense, safer alternative to lithium-ion. Science, pp. 415-418).

Because of process characteristics, the pore size and pore structure of such systems are limited. The structure is characterized by the powder basic material, and binders have often to be employed for retaining the structures. The structures thus prepared have the disadvantage that this is not a consistently metallic framework. This may lead to a non-uniform dissipation of charge and thus to a selective deposition of zinc during the charging process (DE 60014465 T2).

### SUMMARY

Therefore, there is a need for novel structures or production processes for them that avoid the drawbacks from the prior art. In particular, there is a need for production processes that enable an open porosity. At the same time, the pore size should be settable over as broad a range as possible irrespective of the further dimensions of the molded part as such.

Surprisingly, it has been found that three-dimensional molded parts having an open-cell structure can be obtained by a pressure-difference method. “Open-cell” structure as used in the present application means that the molded part is in the form of a sponge, i.e., has an open metal sponge structure. “Open-cell” solely relates to the structure of the metal independently of whether or not the metal sponge structure is filled with a material other than the metal. Such molded parts can be used as an anode, especially of a primary or secondary battery.

In a first embodiment, the object of the present invention is achieved by a process for preparing a three-dimensional open-cell metallic molded part for use as an anode, especially in primary or secondary batteries and all-solid-state batteries, wherein said metal is selected from zinc, tin, lead, indium, aluminum, magnesium, or bismuth, or suitable alloys of such metals, comprising the following steps:
a) providing a molten metal,
b) providing a three-dimensional casting mold, which has a first opening and a second opening, wherein the first opening in the direction of space represents the lower end of the casting mold, and the second opening in the direction of space represents the upper end,
c) filling the casting mold with a placeholder that is in the form of solid granules at the melting temperature of the metal,
d) contacting the molten metal with the first opening of the casting mold,
e) applying a pressure difference between the first opening and the second opening of the casting mold, whereby the molten metal gets into the interior of the casting mold, followed by
f) allowing the molten metal to solidify in the interior of the casting mold.

The process according to the invention enables a metallic molded part having an open-cell metal sponge structure to be prepared. “Open-cell” relates to the structure of the metal sponge as such independently of whether or not the cells or pores contained therein are filled with a material other than the metal.

According to the invention, the process may further comprise the step of:
g) removing the placeholders from said three-dimensional molded part.

Said removing of the placeholders can be effected completely or else partially. According to the invention, it is also possible that the placeholders are not removed, and then remain in a filled metal sponge structure as a process material.

Thus, in a preferred embodiment, the process according to the invention may comprise the following steps:
a) providing a molten metal,
b) providing a three-dimensional casting mold, which has a first opening and a second opening, wherein the first opening in the direction of space represents the lower end of the casting mold, and the second opening in the direction of space represents the upper end,
c) filling the casting mold with a placeholder that is in the form of solid granules at the melting temperature of the metal,
d) contacting the molten metal with the first opening of the casting mold,
e) applying a pressure difference between the first opening and the second opening of the casting mold, whereby the molten metal gets into the interior of the casting mold, followed by
f) allowing the molten metal to solidify in the interior of the casting mold, and
g) partially removing the placeholders from said three-dimensional metallic molded part.

Especially preferably, said process comprises the following steps:
a) providing a molten metal,
b) providing a three-dimensional casting mold, which has a first opening and a second opening, wherein the first opening in the direction of space represents the lower end of the casting mold, and the second opening in the direction of space represents the upper end,
c) filling the casting mold with a placeholder that is in the form of solid granules at the melting temperature of the metal,
d) contacting the molten metal with the first opening of the casting mold,
e) applying a pressure difference between the first opening and the second opening of the casting mold, whereby the molten metal gets into the interior of the casting mold, followed by
f) allowing the molten metal to solidify in the interior of the casting mold, and
g) completely removing the placeholders from said three-dimensional metallic molded part.

After said allowing to solidify according to step f) of the process according to the invention, the metallic molded part can be removed from the casting mold. However, it is also possible according to the invention to leave the metallic molded part in the casting mold, and if desired, to remove the placeholder from the metallic molded part while still in the casting mold. However, it is also possible according to the invention to remove the placeholder completely or partially from the metallic molded part outside the casting mold.

In a further embodiment, the object of the present invention is achieved by a metallic molded part having an open-cell sponge structure, obtained by the process according to the invention.

In a still further embodiment, the object of the present invention is achieved by the use of such a metallic molded part having an open-cell sponge structure as an anode, especially in primary or secondary batteries, or all-solid-state batteries.

These embodiments and preferred designs are explained in more detail in the following: The features explained hereinbelow may be combined in any way desired. Even if they are shown only in connection with one embodiment, they apply to all embodiments, unless explicitly stated otherwise.

### BRIEF DESCRIPTION OF THE DRAWINGS

FIG. 1 schematically shows the procedure of the present invention.

FIG. 2 shows a cross-section of a molded part with different pore sizes and distributions, which were prepared by the process according to the invention.

FIG. 3 shows a cross-section of another molded part with different pore sizes and distributions, which were prepared by the process according to the invention.

FIG. 4 shows the images on the basis of which the metallographic determination of the specific surface area of the structures shown in FIG. 2 and FIG. 3 was made.

FIG. 5 shows charging and discharging capacities associated with a test cell subjected to cycles of charging and discharging, the currents and voltage being recorded.

### DETAILED DESCRIPTION

The process according to the invention enables metallic molded parts having an open-cell metal sponge structure to be prepared by a smelting metallurgical process with functional placeholders. As the metal from which said metal sponge structure is formed, battery alloys may be used, i.e., metals and alloys that are being used as electrodes in a primary or secondary battery. According to the invention, these include zinc, tin, lead, indium, aluminum, magnesium, bismuth, or suitable alloys of such metals.

Said functional placeholder is in the form of granules, which are solid at the melting temperature of the corresponding metal or alloy. The sizes and shapes of the granules, i.e., of the individual particles, determine the porosity of the metallic molded part prepared. Thus, the placeholder enables freely settable three-dimensional structures to be obtained by selecting different sizes and shapes of granules, and a statistical distribution thereof.

According to the invention, salts or oxides are used as functional placeholders, preferably a salt, especially an inorganic salt. The choice of the salt is dependent, on the one hand, on whether or not it is to be removed after said allowing the molten metal to solidify. On the other hand, the later desired structure of the molded part is a factor affecting the choice of the placeholder. For example, sodium chloride, potassium fluoride, potassium chloride, calcium hydroxide, lithium hydroxide, lead (IV) oxide, zinc oxide, or zinc sulfate, or mixtures of two, three or more of such compounds can be employed as placeholders.

In a preferred embodiment, the granules do not contain any binders. Thus, according to the invention, the granules can be introduced into the casting mold without a specific pretreatment. No binder has to be removed after the preparation of the metallic molded part, and possible side reactions do not have to be taken into account.

The omitting of binders is enabled by the process according to the invention, in which the liquid molten metal intrudes the casting mold from the bottom to the top against gravity. If the molten metal is added into a casting mold filled with a placeholder from above, the placeholder will float on top. Then, the originally planned structure, which is to be brought about by the placeholder, does not longer exist. Reproducibility of the structure is almost impossible. In order to prevent this, binders may be employed, which keep the placeholder from floating on top. However, compounds and pathways between the granules of the placeholder are already filled by the binder thereby, so that the exact structure of the metallic molded part is again hard to predict. In addition, the binder has to be chosen to be not disadvantageous for the later application. Although numerous suitable binders are disclosed in the prior art, the process according to the invention now enables for the first time binders to be omitted. Therefore, in a preferred embodiment, the placeholder according to the invention is free of binders.

In an embodiment of the process according to the invention, the process according to the invention includes step g) of completely or partially removing the placeholder from said three-dimensional metallic molded part. Preferably, this is effected by removing the placeholder by rinsing. In an alternative embodiment, which is also preferred, the placeholder remains in the network structure as a process material.

Thus, the process according to the invention enables the provision of a metallic molded part having an open-cell metal sponge structure. The placeholder is present as granules and is introduced into the three-dimensional casting mold as a fill-type. Cavities form between the granules. These cavities are then filled with liquid metal from the molten metal by applying a pressure difference. After solidification, a three-dimensional structure of the type of an open-cell metal sponge structure is obtained, which contains the functional placeholder in the cavities. The latter can be removed completely or partially according to the invention, or it remains within the molded part.

If the removal of the placeholder from the solidified metallic molded part is planned and desired, then preferably a salt that is soluble in a solvent is selected as the placeholder. Particularly suitable are solvents such as water, alcohols, acids or alkalis, ethanol, methanol, diethylether, or tetrahydrofuran. In a particularly preferred embodiment, an inorganic salt that is water-soluble is used as said salt. This enables the placeholders to be removed by rinsing with water.

For example, a chloride salt, such as sodium chloride or potassium chloride, can be used as the salt. The sizes of the respective salt crystals can be set already when the salts are prepared. Alternatively, the sizes of the salt crystals can be adjusted to a desired size, for example, by grinding and sieving.

These salts with the desired particle size and particle size distribution are then introduced into the casting mold. The casting mold has a first opening and a second opening. In order that the placeholder remains in the interior of the casting mold, the latter has a device that provides that the placeholder remains in the interior of the casting mold on at least one of its openings, preferably on the first opening and second opening. It may be, for example, a grid, ceramic filter, nets, glass wool, steel wool, wherein the mesh size of the grid depends on the placeholder, or the size of the placeholder's particles.

The casting mold has a three-dimensional design, in which the interior of the casting mold corresponds to the later design of the molded part. Accordingly, the casting mold has an upper end and a lower end in the direction of space. The height h between these two ends can be selected arbitrarily. The base may have any desired design. It may be round, oval, or polygonal. According to the invention, it is possible that the cross-section of the cast body remains the same over the entire height h. It is also possible according to the invention that the cross-section changes. Thus, there may be tapering from bottom to top, or from top to bottom. Several continuous or discontinuous changes in cross-section are also possible in the course over the height h of the casting mold. Post-processing of the metallic molded part obtained is also possible, whereby complex structures can be obtained.

A pressure difference is produced in the interior of the casting mold according to the invention. According to the invention, this may be achieved by connecting a device for producing a pressure difference, for example, a vacuum pump, to the second opening of the casting mold, which is not contacted with the molten metal. However, it is also possible according to the invention that a pressure that is increased as compared to ambient pressure is produced, by which the molten metal is then pressed upwards into a casting mold against gravity through the lower first opening of the casting mold, which is immersed into the molten metal.

In one embodiment of the invention, the connecting of a vacuum pump to a casting mold is possible in any of different ways. For example, a connection can be used for this purpose, which is connected to the second opening of the casting mold. Here too, the exact type of connection depends on the geometry of the casting mold.

A device for producing a pressure difference may also be a pump for producing a positive pressure. Thus, the pump, which may be connected to the casting mold, can produce a negative pressure or a positive pressure in the interior of the casting mold. Such negative or positive pressure refers to a pressure difference from the ambient pressure. The exact pressure chosen is dependent on the type of molten metal, the type of placeholder, and the exact spatial design of the casting mold.

According to the invention, the casting mold, which is filled with the placeholder, is immersed into the molten metal with the lower first end in the direction of space, on which the first opening is provided. The casting mold is immersed into the molten metal in such a way that the casting mold will be filled with the corresponding metal or the metallic alloy at the end of the process. A complete immersion of the casting mold into the molten metal over the entire height is neither necessary nor desired, since metal adhering to the outside of the casting mold represent an undesirable loss of material. Preferably, the casting mold is immersed into the molten metal for about 10% to 35% of the mold's height.

Subsequently, a pressure difference is applied. Either, the molten metal is sucked into the interior of the casting mold by means of a negative pressure. This completely fills the interstices between the placeholders. Subsequently, the metal solidifies in the casting mold. The solidification behavior can be influenced by the suction speed. The suction speed is controlled by valves and flow through nozzles. The vacuum remains applied also during the solidification, so that a complete filling of the casting mold and cavities is ensured.

According to the invention, applying a negative pressure means that the pressure is lowered to below the atmospheric pressure of 1 bar. Preferably, a negative pressure within a pressure range of from 50 mbar to 900 mbar, especially from 250 mbar to 750 mbar, preferably from 400 mbar to 600 mbar, is set. The exact pressure is dependent on the selected metal or alloy, as well as on the exact three-dimensional design of the casting mold.

According to the invention, applying a positive pressure means that the molten metal is pressed into the casting mold by a positive pressure, for example, through a dosing furnace. Here, the positive pressure is especially within a range of from 10 mbar to 900 mbar, and preferably within a range of from 40 to 500 mbar. This means that the pressure in higher than the ambient pressure by these values.

The process according to the invention enables a uniform and dimensionally stable three-dimensional structure of a metallic molded part with an adapted metal sponge structure. The metal sponge has cavities in its interior. The geometry of the hollow spaces can be adjusted in a controlled way by suitably selecting the placeholder. Thus, spherical or cubic shapes of the cavities can also be adjusted. A porosity of 10-90% by volume can be adjusted thereby. Combinations of and transitions between the geometries of the cavities and the porosity of the molded part can also be realized. Different cavity sizes and cavity structures can be adjusted within a molded part by selectively distributing the placeholder granules. Thus, for example, a fine cavity structure may exist in one region of the molded part, and a coarse cavity structure may exist in another region. This can be realized, for example, by selecting different salts as placeholders. It is also possible that the same salt is employed with different sizes and/or geometries. Then, when the casting mold is filled with the placeholder, regions in which the placeholder exists with the respective size/geometry can be determined. This is later reflected in the corresponding distribution of cavity sizes in the metallic molded part.

By selecting different salts, it is also possible to provide a metallic body in which the placeholder is rinsed out of the cavities of the metal sponge structure only in a subregion, whereas it is further present as a process material in a different subregion of the body. This can be enabled by selecting different salts that are soluble in different solvents. In addition, the process according to the invention enables that no other components are employed in addition to the placeholder and the molten metal. Binders as described in the prior art are not necessarily required. Preferably, the process is characterized in that it is free from the use of binders and that the placeholders or metals or alloys employed do not contain any binders, either.

The porosity also determines the density of the molded part. According to the invention, it is possible to prepare a molded part having a density within a range of from 0.5 to 9.5 g/cm³, wherein the density relates to the molded part without placeholders. If zinc or a zinc alloy having a proportion of zinc of at least 98% by weight is used as the metal, densities within a range of from 0.7 to 6.5 g/cm3 can be realized.

The process according to the invention enables a continuous conductive metal structure to be prepared. The open-cell metal sponge structure enables fluids or gases to flow through. Independently of the size of the metallic molded parts prepared, apart from the casting mold, the placeholder and the molten metal, no other materials, additives, binders or the like are required.

The process according to the invention enables the use of the metallic molded parts prepared according to the invention as anodes in primary or secondary batteries, or all-solid-state batteries. Through the structure, an immediate impact on the cell capacity can be made. The cell life is significantly prolonged. Rearrangement of the active material, for example, in the lower zone of the anode, is suppressed. This results in the anode remaining dimensionally stable, and the service life to be increased.

Surprisingly, it has been found that the zinc remains near the site of discharging during the discharging and can be recovered near the site of discharging during the charging, so that the use in rechargeable batteries, in particular, is preferred. It has been found that the deposition of the metal is concentrated on the middle of the anode. It does not diffuse into the electrolyte. A uniform distribution is preserved.

In addition, it was observed that dendrite growth was clearly reduced, which reduces the risk of a short circuit.

The casting with a pressure difference forms an open-cell metallic molded part, which has a three-dimensional shape predefined by the casting mold, and a defined distribution of cavities in the interior of the metal sponge structure because of the selected placeholder. Thus, complex three-dimensional networks of zinc, tin, lead, indium, aluminum, magnesium, or bismuth structures or structures made of alloys of such metals are obtained. In particular, such structures are suitable for use in anodes in primary batteries (disposable batteries), secondary batteries (rechargeable batteries, accumulators), or also in (three-dimensional) all-solid-state batteries.

The metallic molded parts obtained are strong and dimensionally stable. It is therefore also possible that the metallic molded parts are mechanically processed before or after the removal of the placeholder. Very specific electrode shapes can also be prepared thereby.

With the process according to the invention, metallic molded parts can be prepared that have pore sizes within a range of from 0.01 mm to 20 mm, especially from 0.04 mm to 18 mm, preferably from 0.06 mm to 16 mm, preferably from 0.1 mm to 14 mm. The porosity is preferably from 10-90% by volume, especially from 50-75% by volume, preferably from 60-70% by volume. Because of the open-cell metal foam structure, all the cavities in the interior of the molded part are interconnected. In the case of application as an anode, the process solution is sucked into the molded part because of the capillary forces displayed thereby. Thus, a large surface area and thus a good interaction between the anode and the electrolyte of the battery are obtained. Because of the large surface area, the metallic molded parts obtained may also be used as an anode for the cathodic corrosion protection of steel and steel-reinforced concrete according to the invention.

In the following Example, the present invention is further explained in a non-limiting way.

### Examples

An anode made of battery zinc was prepared by the process according to the invention. The pressure difference was set by applying a negative pressure.

For this, a casting mold having a cylindrical shape with an interior diameter of 55 mm and a length of 1000 mm was provided. The casting mold was filled with sodium chloride having an average particle size of 0.4-1.25 mm. For the sodium chloride, i.e., the placeholder, to remain inside the casting mold, the latter contains a ceramic filter at the lower end in the zone of the opening.

At the upper end (end in longitudinal direction, oriented upwards in space) of the casting mold, a nozzle was connected to the opening provided there, the nozzle being connected to a vacuum pump through a flexible tube.

A negative pressure of 500 mbar was applied. After the casting mold was completely filled and the metal solidified, the sodium chloride was rinsed out with water.

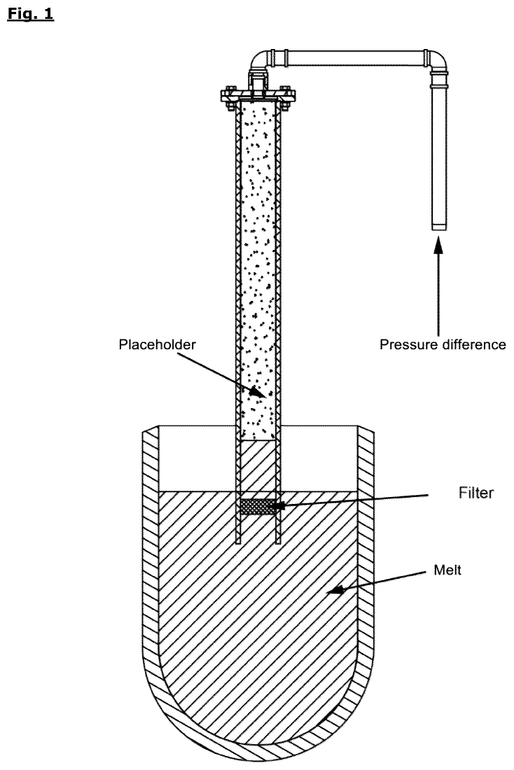

FIG. 1 schematically shows the procedure.

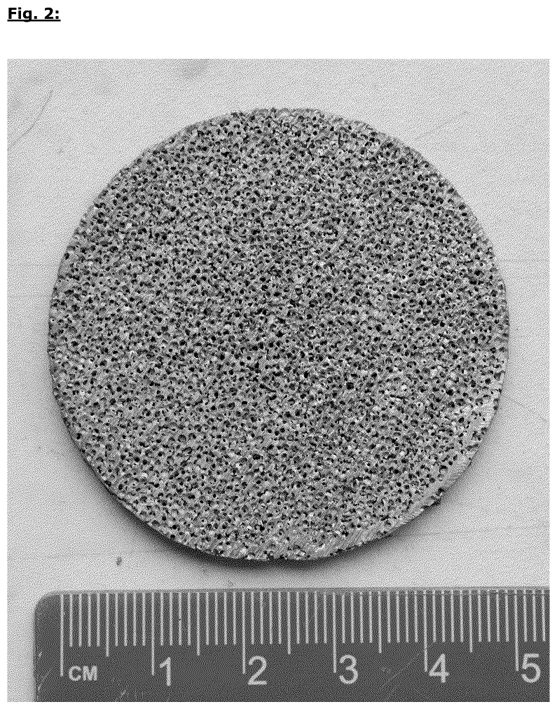

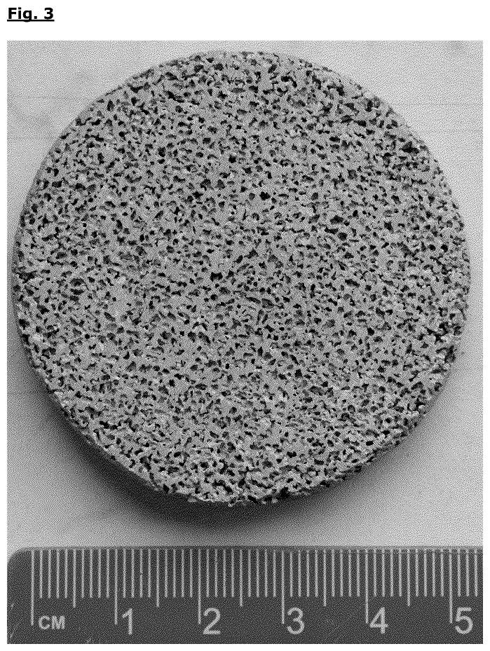

FIGS. 2 and 3 show cross-sections of molded parts with different pore sizes and distributions, which were prepared by the process according to the invention as described in the Example.

A molded part with a fine metal foam structure and a pore size of 0.15 mm to 0.7 mm is shown in FIG. 2. The density was 1.9 g/cm³ with a porosity of 73.4% by volume. The molded part of FIG. 3 had a coarse metal foam structure. The pore size was 0.4 mm to 1.25 mm, and the density was 3.0 g/cm³ with a porosity of 58.0% by volume.

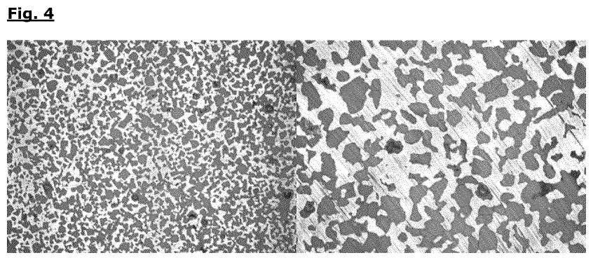

FIG. 4 shows the images on the basis of which the metallographic determination of the specific surface area of the structures shown in FIG. 2 and FIG. 3 was made. The molded body from FIG. 2 is reproduced in FIG. 4 on the left; the molded body according to FIG. 3 is reproduced in FIG. 4 on the right.

The following Table shows the results:

| | Fine sponge | Coarse sponge |
|---|---|---|
| | structure | structure |
| | (FIG. 2, FIG. 4 | (FIG. 3, FIG. 4 |
| | on the left) | on the right) |
| Proportion of surface area in % | 52.7 | 47.4 |
| Total surface area in μm² | 207499000 | 207499000 |
| Total limit length in μm | 1271725 | 621494 |
| Number of pores | 1021 | 280 |
| Specific surface in m²/m³ | 6128.8 | 2995.2 |

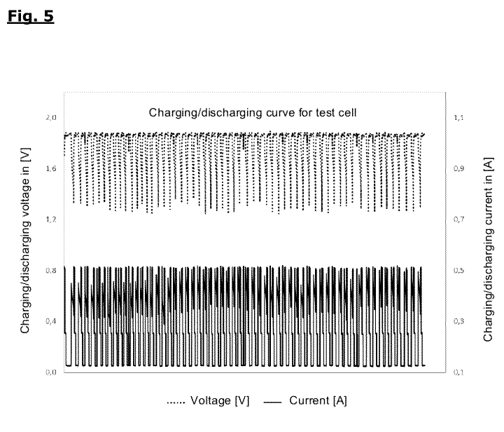

For testing the cycle stability of the metal sponge structure, a test cell in which the cathode consisted of nickel hydroxide (Ni (OH) 2) was chosen. The test cell was subjected to cycles of charging and discharging, and the currents and voltage were recorded. The charging and discharging capacities are shown in FIG. 5. They show that the thus produced test cell works over many cycles without a loss in power.

1. A process for preparing a three-dimensional metallic molded part with an open-cell metal sponge structure for use as an anode in primary or secondary batteries and all-solid-state batteries, wherein said metal is selected from zinc, tin, lead, indium, aluminum, magnesium, or bismuth, or suitable alloys of such metals, comprising the following steps:
a) providing a molten metal,
b) providing a three-dimensional casting mold, which has a first opening and a second opening, wherein the first opening in the direction of space represents the lower end of the casting mold, and the second opening in the direction of space represents the upper end,
c) filling the casting mold with placeholders that are in the form of granules at the melting temperature of the metal,
d) contacting the molten metal with the first opening of the casting mold,
e) applying a pressure difference between the first opening and the second opening of the casting mold, whereby the molten metal gets into the interior of the casting mold, followed by
f) allowing the molten metal to solidify in the interior of the casting mold.

2. The process according to claim 1, characterized in that it further comprises:
g) completely or partially removing the placeholders from said three-dimensional metallic molded part.

3. The process according to claim 1, characterized in that said metal is zinc or a zinc alloy.

4. The process according to claim 1, characterized in that a negative pressure is applied in step e), wherein the pressure is set, in particular, within a range of from 50 mbar to 900 mbar, especially from 250 mbar to 750 mbar, preferably from 400 mbar to 600 mbar.

5. The process according to claim 1, characterized in that a positive pressure is applied in step e), wherein the positive pressure is set, in particular, within a range of from 20 mbar to 10 bar.

6. The process according to claim 1, characterized in that said placeholder is a salt, especially an inorganic salt.

7. The process according to claim 1, characterized in that the size of the cavities in the metallic molded part after solidification is within a range of from 0.01 mm to 20 mm, especially from 0.04 mm to 18 mm, preferably from 0.06 mm to 16 mm, preferably from 0.1 mm to 14 mm.

8. The process according to claim 1, characterized in that the porosity of the metallic molded part is from 10-90% by volume, especially from 50-75% by volume, preferably from 60-70% by volume.

9. The process according to claim 1, characterized in that the density of the metallic molded part made of zinc or a zinc alloy having a proportion of zinc of 98% by weight is from 0.7 to 6.3 g/cm³.

10. The process according to claim 1, characterized in that said contacting in step d) means the immersion of the casting mold with the lower end, on which the first opening is provided, into the molten metal.

11. The process according to claim 10, characterized in that the casting mold is immersed into the molten metal for up to 10% to 35% of the mold's height.

12. The process according to claim 1, characterized in that no binder is employed.

13. The process according to claim 1, wherein the metallic molded part is used as an anode in primary or secondary batteries, or all-solid-state batteries.

14. The process according to claim 1, wherein the metallic molded part is used as an anode for the cathodic corrosion protection of steel and steel-reinforced concrete.

15. The process according to claim 13, characterized in that said metallic molded part is made of zinc or a zinc alloy.
